(19) United States
(12) Patent Application Publication
(10) Pub. No.: US 2008/0207013 A1
(43) Pub. Date: Aug. 28, 2008

(54) Electrical Connector

(75) Inventor: Ted JU, Anloku (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: LOTES CO., LTD, Anloku (TW)

(21) Appl. No.: 12/034,790

(22) Filed: Feb. 21, 2008

(30) Foreign Application Priority Data
Feb. 26, 2007 (CN) 200720048933.3

(51) Int. Cl. H01R 12/30; H01R 12/14

(52) U.S. Cl. 439/66; 439/81

(57) ABSTRACT

An electrical connector, for connecting an electronic device with a circuit board, comprises an insulating substance and conductive terminals, wherein the insulating substance configures a plurality of terminal containing holes and the conductive terminals are configured in the terminal containing holes. The electronic device and the circuit board thereon respectively configure a conductive section electrically connecting with on of the conductive terminals, and an elastic protruding section, pressing on the conductive section or around the conductive section, is configured around each of the terminal containing holes. When the elastic protruding section presses on the electronic device and the circuit board, contact points of the conductive terminals and the electronic device and the circuit board are sealed up in the space surrounded by the elastic protruding section, so as to decrease the contact with air and to decrease the rate of the oxidation of the contact points.

### BACKGROUND OF THE INVENTION

1. Field of the invention

The invention relates to an electrical connector, and more particularly, to an electrical connector for connecting an electronic device with a circuit board.

2. Description of the prior art

At present, an industrial electrical connector for connecting an electronic device with a circuit board generally includes an insulating substance and a plurality of conductive terminals, and a top end and a bottom end of each of the conductive terminals respectively extend to form a contact section. The contact sections protrude out of a surface of the insulating substance and conductively connect with the electronic device and the circuit board respectively. Furthermore, after the assembly of the electrical connector, gaps often exist between the insulating substance and the circuit board, and between the insulating substance and the circuit board, and cause the conductive terminals to be exposed to air so that the surface oxidation of the contact sections of the conductive terminals and pads of the electronic device and the circuit board, is accelerated. With the increase of the transmitting rate and frequency of electronic signal and computer signal, the requirement of quality and stability of the electrical connector is continuously increased. However, the surface oxidation of the contact sections of the conductive terminals and pads of the electronic device and the circuit board inevitably influences the quality of signal transmissions, the stability of signals, and the rate of signal transmission of the electrical connector, so as to influence the use of the electrical connector and decrease the performance of the electrical connector.

Therefore, a new electrical connector design is necessary for overcoming the above-mentioned problem.

### SUMMARY OF THE INVENTION

Accordingly, a scope of the invention is to provide an electrical connector which is capable of decreasing the oxidation rate of the conductive terminals effectively.

To reach the above-mentioned purpose, the invention provides an electrical connector for connecting an electronic device with a circuit board, and the electrical connector includes an insulating substance configuring a plurality of terminal containing holes, and a plurality of conductive terminals respectively configured in the terminal containing holes. The electronic device and the circuit board thereon respectively configure a conductive section electrically connected with one of the conductive terminals. Furthermore, an elastic protruding section, pressing on the conductive section or around the conductive section, is configured around each of the terminal containing hole.

Compared with the prior art, the electrical connector of the invention configures an elastic protruding section, pressed on the conductive section or around the conductive section. When the elastic protruding section is pressed on the electronic device and the circuit board, the contact points between the conductive terminals and the electronic device, and between the conductive terminals and the circuit board, are sealed in the space surrounded by the elastic protruding section, so that the contact with air is decreased and the oxidation rate of the contact points are decreased effectively.

The advantage and spirit of the invention may be understood by the following recitations together with the appended drawings.

### BRIEF DESCRIPTION OF THE APPENDED DRAWINGS

FIG. 1 is a cutaway view illustrating an electrical connector and an electronic device of the invention before compression.

FIG. 2 is a cutaway view illustrating electrical connector and an electronic device of the invention after compression.

### DETAILED DESCRIPTION OF THE INVENTION

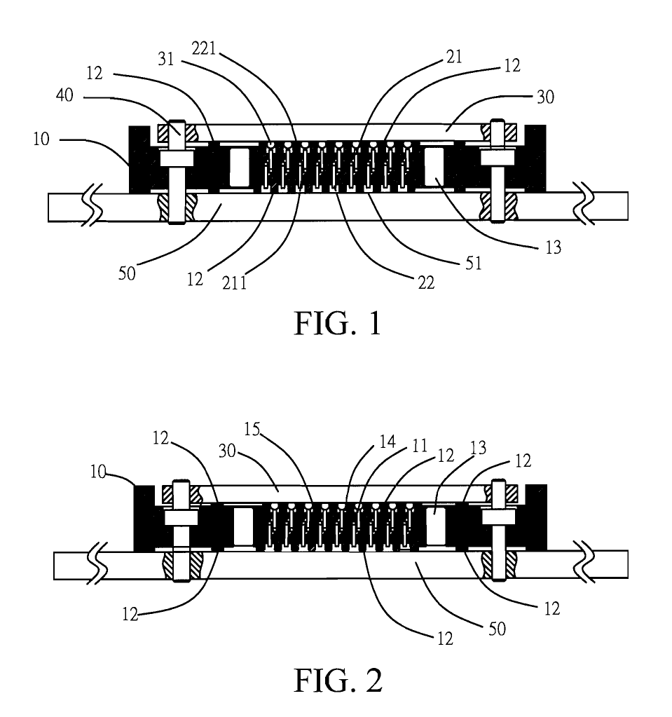

Please refer to FIG. 1 and FIG. 2. The electrical connector of the invention is applied for connecting an electronic device 30 with a circuit board 50. Both of the electronic device 30 and the circuit board 50 configure conductive sections respectively. Furthermore, the electrical connector includes an insulating substance 10 and a plurality of conductive terminals.

The insulating substance 10 configures a plurality of terminal containing holes 11 for containing the conductive terminals, and each of the conductive terminals includes a first conductive terminal 21 and a second conductive terminal 22 matching the first conductive terminal 21. The first conductive terminal 21 compressively connects with the electronic device 30 and the second conductive terminal 22 compressively connects with the circuit board 50. The insulating substance is an elastic object capable of deforming by pressure.

An elastic protruding section 12 is configured around each of the terminal containing holes 11 and protrudes out of a surface of the insulating substance 10 to surround the corresponding terminal containing hole 11 and form a hollow containing space 14 connected with the terminal containing holes 11. When the electronic device 30 is connected to the electrical connector, the elastic protruding section 12 presses on the conductive sections or the surroundings thereof, so as to form an airtight containing space. The contact area between the conductive terminals and the conductive sections is located in the airtight containing space (i.e., the hollow containing space 14), so as to decrease the contact of the conductive terminals and air and then to slow down the oxidation rate of the conductive terminals. Furthermore, the areas of the terminal containing holes 11 on a top and a bottom surface of the insulating substance 10 form a terminal loading area 15. The surroundings of the terminal loading area 15 are configured with protruding elastic objects for further sealing effect. Because the elastic protruding section 12 is an object capable of deforming by pressure, when the elastic protruding section 12 presses on the conductive sections or the surroundings thereof, a good sealing effect is obtained and the oxidation rate of the conductive terminals, the electronic device 30, and the circuit board 50 will be slowed down. In this embodiment, the protruding section and the insulating substance are monolithically formed, on the contrary, the protruding section can be a protruding block or a protruding independent of the insulating substance.

Each of the conductive terminals includes a first conductive terminal 21 and a second conductive terminal 22. Furthermore, one part of the first conductive terminal 21 is configured above the second conductive terminal 22, and the other part of the first conductive terminal 21 is configured to overlap the second conductive terminal 22 in the terminal containing hole 11. The first conductive terminal 21 and the second conductive terminal 22 respectively protrude to form contact sections 211 and 221, and the contact sections 211 and 221 are against the corresponding conductive terminals to enable the first conductive terminal 21 to electrically connect with the second conductive terminal 22. Moreover, the top end of the first conductive terminal 21 is capable of connecting with the electronic device 30, and the bottom end of the second conductive terminal 22 is capable of connecting with the circuit board 50, so that the electronic device 30 is capable of electrically connecting with the circuit board 50 via the first conductive terminal 21 and the second conductive terminal 22.

In practice, the electrical connector further includes a block component 13 and a fixing guiding component 40. The block component 13 is capable of being configured in the insulating substance 10 or being monolithically formed with the fixing guiding component 40. Accordingly, the conductive terminals can be avoided from permanent deformation caused by over-compression of the insulating substance 10 by the electronic device 30. The fixing guiding component 40 is capable of fixing the electronic device 30 on the electrical connector and guides the insert direction of the electronic device to enable the conductive section of the electronic device 30 to contact the first conductive terminal 21 exactly.

In practice, the conductive section of the electronic device 30 and the circuit board 50 is a tin ball 31 and a metal spacer 51 without surface treatment respectively. The metal spacer 51 also can be surface treated by immersion silver or organic solderability preservatives (OSP) so as to further enhance the capability of anti-oxidation of the metal spacer 51.

The invention provides the elastic protruding sections 12 configured around the terminal containing holes 11 to locate the conductive terminals and the conductive sections of the electronic device 30 and the circuit board 50 in the airtight spaces, so that the oxidation rate of the conductive terminals and the conductive sections can be slowed down and the capability of the electrical connector can be increased.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An electrical connector for connecting an electronic device with a circuit board, the electronic device and the circuit board respectively configuring a conductive section, the electrical connector comprising:
an insulating substance, configuring a plurality of terminal containing holes; and
a plurality of conductive terminals, respectively configured in the terminal containing holes;
wherein an elastic protruding section, pressing on the conductive section or around the conductive section, is configured around the terminal containing holes.

2. The electrical connector of claim 1, wherein the elastic protruding section is configured around each of the terminal containing holes.

3. The electrical connector of claim 1, wherein the terminal containing holes form a terminal loading area, and the elastic protruding section is configured around the terminal loading area.

4. The electrical connector of claim 1, wherein the terminal containing holes form a terminal loading area, and the elastic protruding section is configured around each of the terminal containing holes and the terminal loading area.

5. The electrical connector of claim 1, wherein the insulating substance thereon configures a hollow space for containing the conductive section, and the hollow space connects with the terminal containing holes.

6. The electrical connector of claim 1, wherein the elastic protruding section is configured on a top surface of the insulating substance.

7. The electrical connector of claim 1, wherein the elastic protruding section is configured on a top surface and a bottom surface of the insulative substance.

8. The electrical connector of claim 1, wherein the insulating substance is an elastic object capable of deforming by pressure.

9. The electrical connector of claim 1, wherein each of the conductive terminals comprises a first conductive terminal and a second conductive terminal matching with the first conductive terminal.

10. The electrical connector of claim 9, wherein at least one of the first conductive terminal and the second conductive terminal configure a contact section for the connection between the first conductive terminal and the second conductive terminal.

11. The electrical connector of claim 9, wherein the first conductive terminal is compressively connected with the electronic device, and the second conductive terminal compressively connecting with the circuit board.

12. The electrical connector of claim 1, wherein the conductive section of the electronic device is a tin ball.

13. The electrical connector of claim 1, wherein the conductive section is a metal spacer with surface treatment of immersion silver or organic solderability preservatives (OSP) or without surface treatment.
